(19) United States
(12) Patent Application Publication
(10) Pub. No.: US 2014/0306089 A1
(43) Pub. Date: Oct. 16, 2014

(54) MOLD CORE AND METHOD FOR MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 14/223,973

(22) Filed: Mar. 24, 2014

(30) Foreign Application Priority Data
Apr. 10, 2013 (TW) 102112600

(51) Int. Cl. B29C 33/38

(52) U.S. Cl. CPC B29C 33/38
USPC 249/114.1; 427/576

(57) ABSTRACT

A mold core includes a main body including a mold surface, and an aluminum oxide film formed on the mold surface. The aluminum oxide film includes a methylsilane self-assembled monolayer on a surface of the aluminum oxide film away from the main body.

### BACKGROUND

1. Technical Field

The present disclosure relates to molds, and particularly to a mold core and a method for manufacturing the mold core.

2. Description of Related Art

Mold core is usually made of metal and has a bad hydrophobicity. Thus, mold material flowing slowly on the mold core is easily adhered on the mold core, which will influence the precision of the molded product.

Therefore, it is desirable to provide a mold core and a method for manufacturing the mold core that can overcome the shortcomings mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a mold core according to an exemplary embodiment of the present disclosure.

FIG. 2 is a sectional view taken along II-II line of FIG. 1.

FIG. 3 shows a main body of the mold core being put in a reaction chamber.

FIG. 4 shows the main body of the mold core being put above an opened vessel.

FIG. 5 shows a methylsilane self-assembled monolayer is formed on an aluminum oxide film of the mold core.

### DETAILED DESCRIPTION

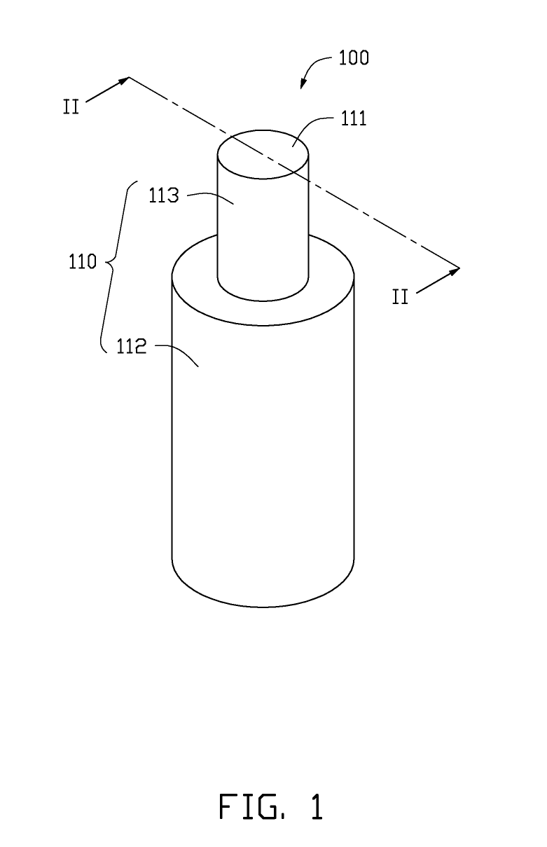

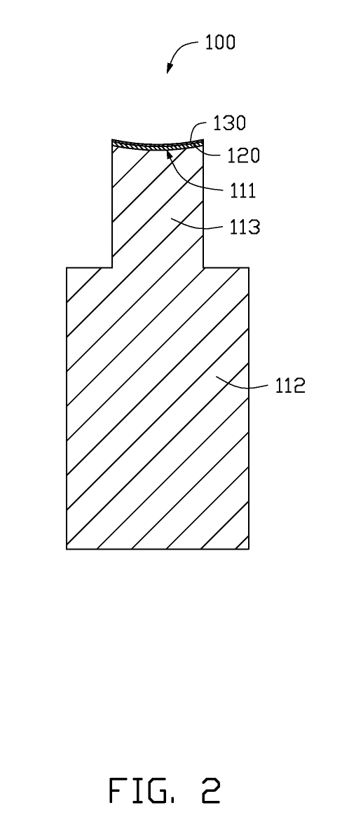

FIGS. 1 and 2 show a mold core 100 according to an embodiment of the present disclosure. The mold core 100 includes a main body 110. The main body 110 includes a mold surface 111. An aluminum oxide film 120 is formed on the mold surface 111. The aluminum oxide film 120 includes a methylsilane self-assembled monolayer 130 formed on a side of the aluminum oxide film 120 away from the main body 110.

The main body 110 includes a cylindrical installation part 112 and a cylindrical mold part 113. A diameter of the installation part 112 is bigger than that of the mold part 113. The installation part 112 and the mold part 113 are coaxial. The mold part 113 includes the mold surface 111 at a distal end. The mold surface 111 can be curved surface, including non-spherical surface and spherical surface. In this embodiment, the mold surface 111 is a concave curved surface. In other embodiment, all outer surfaces of the mold part 113 can be used as mold surfaces to mold a blind hole of a product.

A depth of the aluminum oxide film 120 is in a range from 40 nanometers to 60 nanometers, in the embodiment, the oxide film 120 has a depth of 50 nanometers. The aluminum oxide film 120 can be formed by means of plasma sputtering.

In other embodiments, the aluminum oxide film 120 and the methylsilane self-assembled monolayer 130 can be formed on all surfaces of the mold core 100.

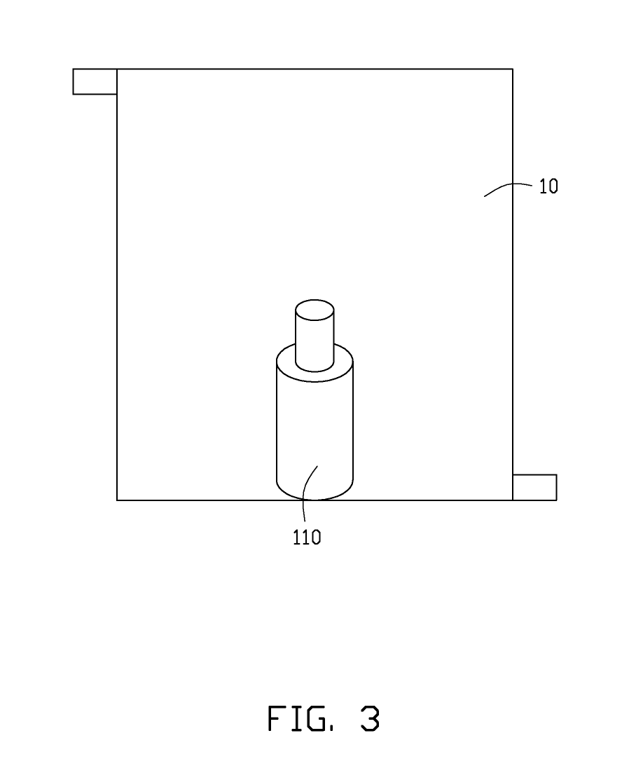

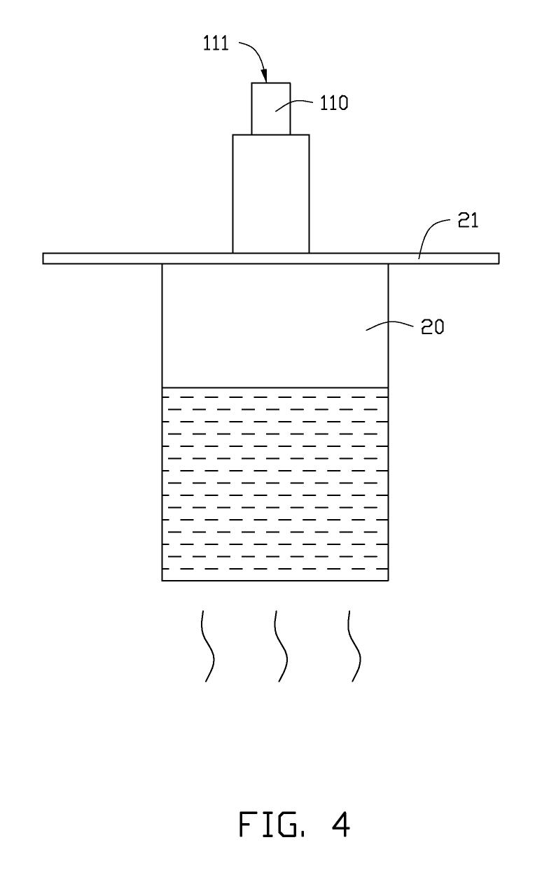

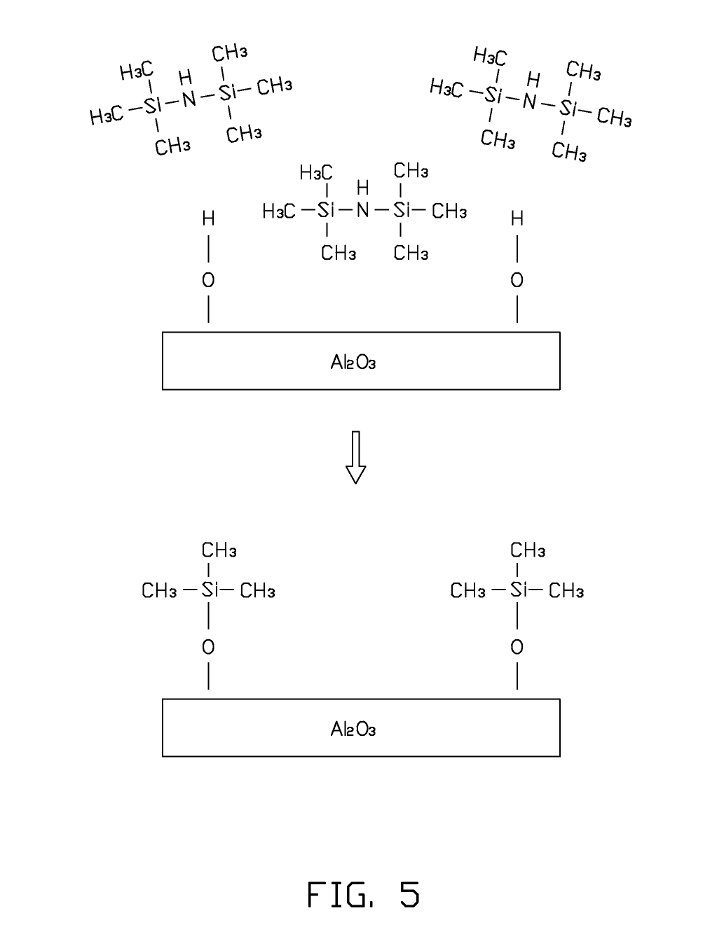

FIGS. 1 and 3 through 5 show a method for manufacturing the mold core 100. The method includes steps of described as follows.

In step 1, the main body 110 is provided.

The main body 110 includes the cylindrical installation part 112 and the cylindrical mold part 113. The diameter of the installation part 112 is bigger than that of the mold part 113. The installation part 112 and the mold part 113 are coaxial. The mold part 113 includes the mold surface 111 at a distal end. The mold surface 111 can be a curved surface, and can include non-spherical surface and spherical surface.

In step 2, the aluminum oxide film 120 is formed on the mold surface 111 of the main body 110.

In this embodiment, the aluminum oxide film 120 is formed by plasma sputtering. In detail, the main body 110 is put in a reaction chamber 10, a vacuum is created in the reaction chamber 10, then the aluminum oxide film 120 is formed on the mold surface 111 by plasma sputtering.

In step 3, the methylsilane self-assembled monolayer 130 is formed on the aluminum film 120.

First, a de-ionized water is used to clear the surface of the aluminum oxide film 120, and the aluminum oxide film 120 reacts with the water to form hydroxyls (—OH). Then, an opened vessel 20 containing hexamethyldisilazan (HMDS) is heated to gasify the HMDS. The cleared aluminum oxide film 120 is put above the opened vessel 20, a grafting action occurs between the gasified HMDS and the hydroxyls of the aluminum oxide film 120, the hydrogen in the hydroxyls is removed, and the hydroxyls is combined to the silicon of the HMDS to obtain the methylsilane self-assembled monolayer 130.

In this step, the opened vessel 20 is heated to a temperature from 95 degrees Celsius to 105 degrees Celsius, in the embodiment a temperature of 100 degrees Celsius is used, and a time from 5 hours to 7 hours, in the embodiment a time of 6 hours. A ventilated filter mesh 21 is set on the open end of the opened vessel 20 to support the main body 110.

Before using the de-ionized water to clear the aluminum oxide film 120, plasma can be used to clear the surface of the aluminum oxide film 120, and after using the de-ionized water to clear the aluminum oxide film 120, a nitrogen gun can be used to blow the water from the aluminum oxide film 120.

The aluminum oxide film 120 has a high rigidity, and the methylsilane has a low surface energy, thus the mold surface 111 has a good hydrophobicity improving the flow ability of the mold material on the mold surface and avoiding the mold material from adhering on the mold surface 111. Furthermore, as the aluminum oxide film 120 and the methylsilane self-assembled monolayer 130 are very thin, the tolerance of the mold surface 111 will not be influenced.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A mold core comprising:
a main body comprising a mold surface; and
an aluminum oxide film formed on the mold surface, and comprising a methylsilane self-assembled monolayer on a surface of the aluminum oxide film away from the main body.

2. The mold core of claim 1, wherein a depth of the aluminum oxide film is in a range from 40 nanometers to 60 nanometers.

3. The mold core of claim 1, wherein the main body comprises an installation part and a cylindrical mold part, the installation part and the mold part are both cylindrical and are coaxial to each other, the mold part comprises the mold surface at a distal end.

4. The mold core of claim 3, wherein the mold surface is a non-spherical surface.

5. The mold core of claim 3, wherein the mold surface is a spherical surface.

6. A method for manufacturing a mold core, comprising:
providing a main body comprising a mold surface;
forming an aluminum oxide film on the mold surface; and
forming a methylsilane self-assembled monolayer on a surface of the aluminum oxide film.

7. The method of claim 6, wherein the aluminum oxide film is formed by plasma sputtering.

8. The method of claim 6, wherein the step of forming a methylsilane self-assembled monolayer on a surface of the aluminum oxide film further comprises:
clearing the aluminum oxide film by de-ionized water to form hydroxyls on the surface of the aluminum oxide film; and
heating an opened vessel containing hexamethyldisilazan (HMDS) to gasify the HMDS, and putting the aluminum oxide film cleared by the de-ionized water above the opened vessel to make the gasified HMDS have a grafting action with the hydroxyls to form the methylsilane self-assembled monolayer.

9. The method of claim 8, further comprising a step of clearing the surface of the aluminum oxide film by plasma before the step of clearing the aluminum oxide film by de-ionized water.

10. The method of claim 8, further comprising a step of blowing off the de-ionized water on the surface of the aluminum oxide film by a nitrogen gun after the step of clearing the aluminum oxide film by de-ionized water.

11. The method of claim 8, wherein in the step of heating the opened vessel, a heating temperature is in a range from 95 degrees Celsius to 105 degrees Celsius, and a heating time is in a range from 5 hours to 7 hours.
